(19) United States
(12) Patent Application Publication
(10) Pub. No.: US 2009/0222418 A1
(43) Pub. Date: Sep. 3, 2009

(54) Systems and methods for dynamic content presentation

(76) Inventor: Timothy B. Layman, Auburn, ME (US)

Correspondence Address: EDWARDS ANGELL PALMER & DODGE LLP, P.O. BOX 55874, BOSTON, MA, 02205, US

(21) Appl. No.: 12/072,975

(22) Filed: Feb. 29, 2008

(51) Int. Cl. G06F 17/30

(52) U.S. Cl. 707/3; 707/E17.014

(57) ABSTRACT

The inventions herein are directed to systems, methods, and computer-readable media for the rapid deployment of data-intensive applications capable of intelligent interactions across multiple data systems so as to provide a user with accurate data in an intelligent manner. The invention is directed, in part, to a method of content presentation including receiving product data, allowing the product to be selected, storing information regarding the manner in which the product was selected, and sending the information to a module.

### FIELD OF INVENTION

The inventions herein are directed to systems, methods, and computer-readable media for the rapid deployment of data-intensive applications capable of intelligent interactions across multiple data systems so as to provide a user with accurate data in an intelligent manner.

### BACKGROUND OF INVENTION

Although the Internet has been ubiquitous for over a decade, electronic commerce (“e-commerce”) applications are still deficient in several respects.

For conventional e-commerce applications, a site or host site must be created that consumers connect to for purposes of searching and completing the desired action (e.g., purchasing a product). In the cases where the host site provides goods or service provided by a third party (e.g., product manufacturer), the host site must acquire data or information about the products or services from the third party. For example, consider an entrepreneur that wishes to sell lighting fixtures from a number of different manufacturers via the Internet. The entrepreneur must manually obtain product information from a number of different manufacturers and enter this data into a website or a database. This product data must be manually updated as the manufacturer adds and deletes products or changes the attributes of a product. As a result, there is often a lag between manufacturer data and e-commerce websites. Also, as a result of these efforts, there is a considerable amount of money and time spent in creating and maintaining the database or website. Furthermore, as the information or data is being transposed from one source to another source, there is the potential for error in the transcription process.

Also, when a consumer visits a conventional e-commerce website, the consumer must use the site in the manner set by the structure created by the website host. Thus, e-commerce applications fail to adequately simulate real world shopping experiences. For example, customers often do not learn that a product is unavailable until they attempt to purchase the product at the transaction phase known as “check out.” Consequently, it is not until the consumer has spent time and energy searching the website database and not until after the consumer has selected the desired product or service before the consumer becomes aware of the actual availability of the product or service.

Also, because existing e-commerce applications cannot obtain data from third parties such as manufacturers or suppliers in real time, products are deemed to be unavailable using existing e-commerce applications if the host site cannot supply the product from the inventory under its control. Consequently, it is not possible for the host site to attempt to fill an order based on the product being available from the manufacturer, wholesaler or warehouse. It should be noted that in some cases, product availability is determined based on computer records that can be out of date and so it is possible that a consumer can be advised after completing the purchasing activity, that the product that was purchased is unavailable.

Conventional e-commerce applications also fail to adequately preserve a user's shopping history for use when connecting to the application at a later time. Traditional e-commerce applications employ cookies (text stored on a user's computer) to maintain state between sessions. However, cookies rarely capture all information that a user or an application developer would wish to capture. Moreover, many consumers have a negative perception of cookies due to privacy concerns. Accordingly, many consumers do not allow their computer to store cookies, and still other consumers periodically purge all cookies from their systems.

Also, because of the drain on computer resources as well as the intrusion by spy-ware, most anti-spyware programs identify cookies found on the computer for removal. Thus, even if a cookie could capture the desired information it would not be available because it would be removed while running an anti-spyware program.

Conventional e-commerce applications also lack the “intelligence” that users seek. For example, a consumer shopping for clothing is often forced to browse through all pants offered by a retailer even though the retailer does not currently carry the user's size in several styles of pants. Likewise, existing e-commerce applications are not intelligent enough to tailor the presentation of information based on a user's accumulated preferences. Moreover, existing e-commerce applications fail to effectively capture and utilize data information on how users discover products. Thus, when a consumer returns to an e-commerce application, the repeat visit involves the same steps and actions as was done for the first visit to the website. For example, the consumer would gain have to enter the width and length or size for the pants they wish to purchase even if they had inputted this information on a prior visit.

It thus would be desirable to provide a new system, application program(s) and methods that address the above-described shortcomings for conventional e-commerce applications. It would be particularly desirable to provide such systems, programs and methods that would allow for the interchange of information and/or data between third parties such as manufacturer and the host applications program thereby facilitating the creation of the database for the host applications program and updating same. It also would be desirable to provide such systems, programs and methods so as to create a better environment for one connecting to the host applications program. Such systems, programs and methods preferably are such that the consumer or client can interface with the host applications using conventional computer hardware now or hereinafter available.

### SUMMARY OF THE INVENTION

The present invention features a method of data exchange including obtaining data describing a product or service from one or more databases, persistently storing the obtained data in binary format, and providing the persistently stored data in binary format to an application. In further embodiments, said persistent storing includes obtaining the data from the one or more databases so as to create an initial persistent storage of the data in binary form and thereafter automatically obtaining data from the one or more databases and updating the data in binary form in the persistent storage to reflect any changes to the data in the one or more databases. In more particular embodiments, such automatically obtaining data is undertaken at least periodically and preferably with sufficient frequency so that data updates are in effect in real time or near real time.

In particular embodiments, a third party controls the one or more databases and the application is implemented on a local or remote client. In some embodiments, the step of obtaining data from a database includes sending a request to an interface for the database. In an exemplary embodiment, the interface is a SOAP interface and the binary format is an Action Message Format. In further embodiments the data describing a product includes an image or other information such as product attributes, price, and quantity.

In some embodiments, the step of persistently storing the data includes storing the data in local memory. However, in other embodiments, the step of persistently storing the data comprises storing the data in a database, a file system, a storage area network (SAN), a network attached storage (NAS) device, and/or via a storage web service.

Also featured is a computer-readable medium on which is stored an applications program having instructions, criteria and/or code segments that causes a computer to perform a method of data exchange including obtaining data describing a product from a database, persistently storing the data in binary format, and providing the data in binary format to an application as described herein

Another featured method is a method of dynamically fulfilling an order including sending product information to a client; receiving updated product information; sending the updated product information to the client; receiving an order for a product from the client; and routing the order for fulfillment from available stock. In particular embodiments, such steps are carried out periodically and preferably with such a periodicity that the steps are carried out in effect in real time or near real time.

In some embodiments, the method also includes sending a request for product information to a third party, and receiving a response to the request from the third party. The step of routing the order for fulfillment from available stock can include querying an inventory system to determine if the product is available from local stock, and fulfilling the order from local stock if the product is available in local stock. The step of routing the order for fulfillment from available stock can include sending the order to the third party if the product is not available from local stock.

Also featured is a computer-readable medium on which is stored an application program having instructions, criteria and/or code segments that cause a computer to perform a method of dynamically fulfilling an order including sending product information to a client, receiving updated product information, sending the updated product information to the client, receiving an order for a product from the client, and routing the order for fulfillment from local stock as described herein.

Another featured method is a method of content presentation including receiving product data, allowing the product to be selected, storing information regarding the manner in which the product was selected, and sending the information to a module.

In some embodiments, the data is in action message format. The method can also include converting the data from acting message format to vector graphics format. In further embodiments, the method includes displaying a graphical representation of the data describing a product.

The method can also include receiving a search query. In some embodiments, the step of storing information regarding the manner in which the product was selected includes storing data about the search query in the product data. In other embodiments, the step of storing information regarding the manner in which the product was selected includes storing data about the search query as data as user data. The method can also include adding user data to product data for a selected product. In other embodiments, the method includes receiving updated product data and displaying the updated product data.

Also featured is a computer-readable medium on which is stored an application program having instructions, criteria and/or code segments that cause a computer to perform a method of content presentation including receiving data describing a product, allowing the product to be selected, storing information regarding the manner in which the product was selected, and sending the information to a module as described herein.

Other aspects and embodiments of the invention are discussed below.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 depicts an illustrative environment for data communication including a data source system, a data processing system, a data storage system, and a client.

FIG. 2 depicts a method according to the present invention for aggregating data from multiple sources.

FIG. 3 depicts a method according to the present invention for presenting data to a user, responding to user input, and accumulating metadata about the user and/or the product.

FIG. 4 depicts a method according to the present invention for providing current data to a client and dynamically fulfilling an order.

FIGS. 5A-5D depict interactions between a user and a client that illustrate how metadata is accumulated according to the present invention.

### DEFINITIONS

The instant invention is most clearly understood with reference to the following definitions:

As used in the specification and claims, the singular form “a,” “an,” and “the” include plural references unless the context clearly dictates otherwise.

A computer readable medium shall be understood to mean any article of manufacture that contains data that can be read by a computer or a carrier wave signal carrying data that can be read by a computer. Such computer readable media includes, but is not limited to, magnetic media, such as a floppy disk, a flexible disk, a hard disk, reel-to-reel tape, cartridge tape, cassette tape or cards; optical media such as CD-ROM and writeable compact disc; magneto-optical media in disc, tape or card form; paper media, such as punched cards and paper tape; or on carrier wave signal received through a network, wireless network or modem, including radio-frequency signals and infrared signals.

XML is defined as Extensible Markup Language, a markup language as specified by the World Wide Web Consortium and other entities.

SOAP is defined as a protocol for XML-based messages over a computer network.

### DETAILED DESCRIPTION OF THE INVENTION

Systems, methods, and computer-readable medium are provided for highly scalable, adaptable, and intelligent communication and data processing. The inventions are described for illustrative purposes in the context of general and specific e-commerce applications. However, one skilled in the art will recognize that the inventions can be adapted to a variety of other e-commerce applications including, but not limited to securities and commodities trading, statistical collection and analysis, and data aggregation services such as or similar to those offered under the LEXISNEXIS® mark by Reed Elsevier Plc of London, England.

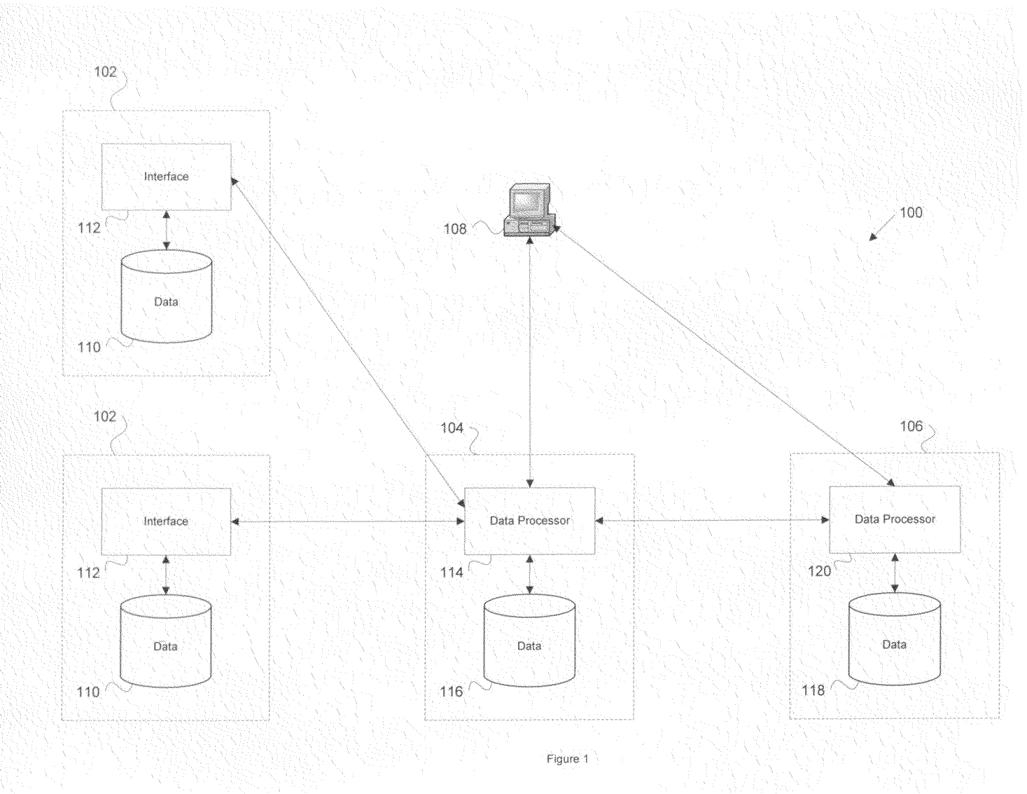

Referring to FIG. 1, an illustrative environment 100 is depicted for purposes of describing the systems, methods, and computer readable media according to the present invention. The illustrative environment 100 includes a data source system 102, a data processing system 104, a data hosting system 106, and a client 108. It should be recognized that the environment depicted in FIG. 1 is illustrative and that the system, methods, and computer readable media of the present invention shall not be limited to the particular elements as illustrated.

In some embodiments, the data source system 102 is controlled by a third party such as a manufacturer or wholesaler. Additionally, the system, methods, and computer readable media will often interact with several different data source systems. For example, if the inventions are used in the context of an e-commerce site for lighting fixtures, each manufacturer (e.g. Hampton Bay, Thomasville Lighting) provides access to data through a data source system.

The data processing system 104 will often be controlled by an entity, such as a retailer, that offers data, (e.g. in the form of a website) to one or more users or clients. As discussed herein, the entity controlling the data processing system 104 is often faced with the challenge of assembling and presenting data, which is gathered from disparate sources, i.e. multiple data source systems 102 that embody different architectures for storing and presenting data.

In some embodiments, the data hosting system 106 is under the direct control and/or ownership of the entity (e.g. a retailer) controlling the data processing system or is provided as a service. The data hosting system 106 is a location for storage of the data that is received from the data source system(s) 102 and processed by the data processing system(s) 104. The data hosting system also communicates with one or more clients 108.

Client(s) 108 are systems that access data stored in the data processing system(s) 104 and/or the data storage system(s) 106. In some embodiments of the invention, retail customers control the client(s) 108. In other embodiments, the client(s) 108 are controlled by other entities such as business customers or operate independent of any human interaction.

Data source system 102 includes a database 110 and an interface 112. Databases such as database 110 are known to those of skill in the art and include hardware or software devices implementing database technology such as Oracle® SQL, available from Oracle Int'l Corp of Redwood City, Calif., DB2® and Informix® both available from IBM Corp. of Armonk, N.Y.; Microsoft Jet® and Microsoft SQL Server® both available from the Microsoft Corp. of Redmond, Wash.; MySQL® available from the MySQL Ltd. Co. of Stockholm, Sweden; and Sybase® available from Sybase, Inc. of Dublin, Calif. Alternatively, database 104 can be replaced and/or supplemented by any system, apparatus, or module for storing data such as file systems, network attached storage (NAS) devices, and storage area network (SAN) devices. Such devices are well known to those of skill in the art.

Interface 112 enhances communication between the data processing system 104 and database 110. Interface 112 can be an abstraction of database 110 provided by database 110 for communication. For example, one or more database platforms can support a common set of functions that can be used to access data in the databases. Examples of such an interface are the Open Database Connectivity (ODBC) and Java Database Connectivity (JDBC) standards known to those of skill in the art.

Alternatively, interface 112 is a separate software and/or hardware component that processes requests for data stored in database 110. For example, interface 112 can provide a SOAP interface for sending XML-based requests for data residing in database 110. The SOAP protocol is described at http://www.w3.org/TR/soap12-part1/, the content of which is hereby incorporated by reference herein. Interfaces are described in Yun-Tung Lau, The Art of Objects 128-29 (2001), the content of which is hereby incorporated by reference herein.

Data processing system 104 can communicate with interface 112 in a number of ways, for example through the use of channels or polling. Under a channel or socket architecture, the data processing system 104 and interface 112 can communicate with each other by writing to the socket or the channel in the same or similar manners as the system would write to an input/output (I/O) device such as a disk. Channels and sockets are well known in the art and are implemented, for example, in the java.nio.channels package of the JAVA® programming language. See, e.g., 1 Patrick Chan, The Java Developers Almanac 1.4 128-46 (2002); 1 W. Richard Stevens, UNIX Network Programming (2d ed. 1998). When a communication is received over the channel, the receiving system is automatically notified.

In contrast, under a polling structure, the data processing system 104 periodically contacts the interface 112. Polling can occur over a channel or socket architecture or can occur over any other communication method such as HTTP. Accordingly, the receiving system in a polling system must periodically check for new communications.

As is seen, the communication between interface 112 and data processing system can occur using a variety of technologies. For example, if the interface 112 implements SOAP, a message resembling the following can be sent to interface 112.

```
<SOAP-ENV:Envelope
xmlns:SOAPENV=“http://schemas.xmlsoap.org/soap/envelope/”
xmlns:xsd=“http://www.w3.org/2001/XMLSchema”
xmlns:xsi=“http://www.w3.org/2001/XMLSchema-instance”>
  <SOAP-ENV:Body SOAP-
ENV:encodingStyle=“http://schemas.xmlsoap.org/soap/encoding/”>
    <intf:getData xmlns:intf=“http://cfc.flex2btb”/>
  </SOAP-ENV:Body>
</SOAP-ENV:Envelope>
```

An exemplary response to the above exemplary request follows:

```
<soapenv:Envelope
xmlns:soapenv=“http://schemas.xmlsoap.org/soap/envelope/”
xmlns:xsd=“http://www.w3.org/2001/XMLSchema”
xmlns:xsi=“http://www.w3.org/2001/XMLSchema-instance”>
  <soapenv:Body>
    <ns1:getDataResponse
soapenv:encodingStyle=“http://schemas.xmlsoap.org/soap/encoding/
” xmlns:ns1=“http://cfc.flex2btb”>
      <getDataReturn soapenc:arrayType=“xsd:anyType[6]”
xsi:type=“soapenc:Array”
xmlns:soapenc=“http://schemas.xmlsoap.org/soap/encoding/”>
      <getDataReturn xsi:type=“ns2:Map”
xmlns:ns2=“http://xml.apache.org/xml-soap”>
            <item>
          <key xsi:type=“soapenc:string”>brand</key>
          <value xsi:type=“soapenc:string”>Kichler</value>
            </item>
            <item>
          <key xsi:type=“soapenc:string”>brand</key>
          <value xsi:type=“soapenc:string”>Hampton Bay</value>
        </item>
      </getDataReturn>
      </getDataReturn>
    </getDataReturn>
  </ns1:getDataResponse>
</soapenv:Body>
</soapenv:Envelope>
```

Data processing system 104 includes a data processing module 114 and can optionally include a database 116 or other storage device as described herein. Data processing module 114 can be any hardware or software device capable of communicating with the data source system 102, the data storage system 106, and/or the client 108. Suitable devices include, but are not limited to general-purpose computers, including, but not limited to computers with higher processing power colloquially known as servers.

As illustration, a server typically includes a central processing unit including one or more microprocessors such as those manufactured by Intel Corporation of Santa Clara, Calif. or Advanced Micro Devices (AMD) of Sunnyvale, Calif., random access memory (RAM), mechanisms and structures for performing I/O operations, a storage medium such as a magnetic hard disk drive(s), and an operating system for execution on the central processing unit. The hard disk drive of the servers can be used for storing data, applications and the like utilized by applications. The hard disk drives of the server also are typically provided for purposes of booting and storing the operating system, other applications or systems that are to be executed on the servers, paging and swapping between the hard disk and the RAM.

It is envisioned that the server can utilize multiple servers in cooperation to facilitate greater performance and stability of the subject invention by distributing memory and processing as is well known. For reference, see, for example, U.S. Pat. No. 5,953,012 to Venghte et al. and U.S. Pat. No. 5,708,780 to Levergood et al., the contents of which are hereby incorporated by referenced herein.

Data processing module 114 communicates with the data source system 102 to request and receive data. The data can include a variety of attributes to reflect the variety of scenarios to which the inventions herein can be applied. For example, in an e-commerce scenario, a wholesaler or a manufacturer can control the data source system 102, while a retailer can control the data processing system 104. In such a scenario, the data can include information about products to be sold on the retailer's website (e.g. product specifications, quantity available, photographs of the product.)

Data processing module 114 converts the data received from the data source system into a binary format for storage. The data processing module can receive data in a variety of formats, for example, in Extensible Markup Language (XML). XML is known to those of skill in the art and is described in Ramez Elmasri & Shamkant B. Navathe, Fundamentals of Database Systems 937-58 (5th ed. 2007), the content of which is hereby incorporated by reference herein. Data can be stored in a variety of binary formats including, but not limited to, Action Message Format (AMF). Action Message Format is a compact binary format used to serialize ActionScript object graphs. Action Message Format is defined in Adobe Systems, Action Message Format—AMF 3 (2007), available at http://download.macromedia.com/pub/labs/amf/amf3_spec_{—}121207.pdf, the content of which is hereby incorporated by reference herein. AMF is implemented as part of the mx.messaging.channels package in the ADOBE® FLEX® programming language.

The binary data can be stored within the data processing system, for example, in database 116 or the data can be transferred to data storage system 106. Data processing system 106 includes a database 118 or other data storage device as described herein. Data processing system 106 also includes a data processing module 120. Data processing module can be any system, device, or apparatus as described herein capable of communicating with the data processing system 104, database 118, and/or client 108.

In some embodiments, data storage system 106 is collocated with data processing system 104, for example in a data center controlled by a retailer. Alternatively, data storage system 106 is provided as a web service. In such a system, a third party provides the functionality of database 118 and/or data processing module 120. Through the use of interface and/or well-defined functions, the components herein interact with the web service in much the same way as if database 118 and data processing module 120 were collocated with the other components described herein. Suitable web services include, for example, Amazon Simple Storage Service (Amazon S3) and Amazon Elastic Compute Cloud (Amazon EC2) provided by Amazon.com of Seattle, Wash., and services available from providers such as Nirvanix of San Diego, Calif., EMC Corporation of Hopkinton, Mass., and Dell Inc. of Round Rock, Tex.

The client 108 typically includes a central processing unit including one or more micro-processors such as those manufactured by Intel or AMD, random access memory (RAM), mechanisms and structures for performing I/O operations (not shown), a storage medium such as a magnetic hard disk drive(s), a device for reading from and/or writing to removable computer readable media and an operating system for execution on the central processing unit. According to one embodiment, the hard disk drive of the client 108 is for purposes of booting and storing the operating system, other applications or systems that are to be executed on the computer, paging and swapping between the hard disk and the RAM and the like. In one embodiment, the application programs reside on the hard disk drive for performing the functions in accordance with the transcription system. In another embodiment, the hard disk drive simply has a browser for accessing an application hosted within a distributed computing network. The client 108 can also utilize a removable computer readable medium such as a CD or DVD type of media, PCMCIA, Flash memory or the like, that is inserted therein for reading and/or writing to the removable computer readable media (e.g. removable hard disks, magnetic tape).

The client 108 can be a desktop computer, laptop computer, personal digital assistant (PDA), cellular telephone and the like now known and later developed. The client 108 can have display(s) as will be appreciated by those of ordinary skill in the pertinent art. The display can be any of a number of devices known to those skilled in the art for displaying images responsive to outputs signals from the client 108. Such devices include, but are not limited to, cathode ray tubes (CRT), liquid crystal displays (LCDs), plasma screens and the like. Although a simplified diagram is illustrated in FIG. 1, such illustration shall not be construed as limiting the present invention to the illustrated embodiment. It should be recognized that the signals being output from the computer can originate from any of a number of devices including PCI or AGP video boards or cards mounted within the housing of the client 108 that are operably coupled to the microprocessors and the displays thereof.

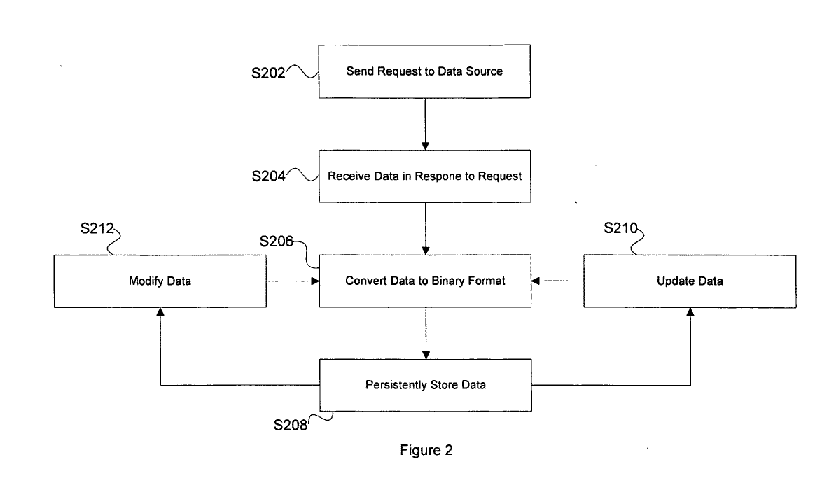

Referring now to FIG. 2, a flow chart 200 is provided depicting a method according to the present invention for aggregating data from multiple sources, which can be embodied in processing module 114. The flowcharts herein illustrate the structure of the logic of the present invention as embodied in computer program software for execution on a computer, digital processor or microprocessor. Those skilled in the art will appreciate that the flow charts illustrate the structures of the computer program code elements, including logic circuits on an integrated circuit, that function according to the present invention. As such, the present invention is practiced in its essential embodiment(s) by a machine component that renders the program code elements in a form that instructs a digital processing apparatus (e.g., computer) to perform a sequence of function step(s) corresponding to those shown in the flow diagrams.

The method of the present invention also includes those actions and processes necessary for carrying out the actions further described herein. Such actions includes for example, loading applications programs and booting up operating system as well as interconnecting the respective functionalities described hereinafter to a communications network, such as for example the Internet, so as to allow communications to occur between such functionalities.

In step S202, the data processing module 114 sends a request to the data source system 102. The request is for data residing in the data source system 102. For example, in a lighting e-commerce system, a request can be sent for data regarding all or some lighting fixtures offered for sale by a lighting manufacturer or wholesaler. The request can also be tailored to reflect the needs and/or agreements of the party implementing the method. For example, a retailer that only sells residential lighting fixtures may not be interested in (and/or may not be allowed by the manufacturer to view) commercial and industrial lighting fixtures. The request can be defined by one or more standards known to those of skill in the art or can be a defined by a proprietary standard. The request can be directed directly to database 110 or can be directed to interface 112 as described herein.

In step S204, a response to the request is received. The format of the response can be defined by one or more standards known to those of skill in the art or can be a defined by a proprietary standard. For example, the response can be in XML format such as that depicted below:

```
<?xml version=”1.0” standalone=”yes”?
    <Lighting Fixtures>
        <Lighting Fixture>
        <Model Number>A1324</Model Number>
        <Type>Track Lighting</Type>
    <Finish>Brushed Nickel</Finish>
    </Lighting Fixture>
. . .
    <Lighting Fixture>
        <Model Number>N2346</Model Number>
        <Type>Bath Vanity</Type>
        <Finish>Polished Brass</Finish>
    </Lighting Fixture>
</Lighting Fixtures>
```

In step S206, the data received in step S204 is converted into a binary format. The binary format allows for the data to be transmitted serially to data storage system 106 and/or client 108. In some embodiments, the data is stored in Action Message Format as described herein. In more particular embodiments, such conversion occurs automatically so that the received data is automatically converted to a binary format that is usable thereafter as described herein. This is in contrast, to conventional e-commerce applications where such data is obtained and manually entered and/or manually converted into a format and data stream unique to the website hosting the data. In comparison to conventional e-commerce applications, this conversion process of the present invention reduces the time and resources committed to converting obtained data as compared to that required for conventional applications. Also and as described herein, this conversion process also allows for automatic updating of the binary data, in effect in real time or near real time.

If the data received in step S204 includes one or more images, the images can be converted to a vector graphics format. Vector graphics (also called geometric modeling or object-oriented graphics) utilize geometrical primitives such as points, lines, curves, and polygons to represent images. Examples of vector graphics formats include the Scalable Vector Graphics (SVG) and Vector Markup Language (VML) formats. The SVG format is defined at W3C, Scalable Vector Graphics (SVG), http://www.w3.org/Graphics/SVG/, the contents of which is hereby incorporated by reference herein. VML is described in Brian Matthews, et al., Vector Markup Language (VML), http://www.w3.org/TR/1998/NOTE-VML-19980513, the contents of which is hereby incorporated by reference herein. Alternatively, the images can be converted to or maintain in a raster graphics format, which is a representation of images as a collection of pixels. Examples of raster graphics formats include JPEG, TIFF, RAW, PNG, GIF, and BMP.

In step S208, the converted data is stored. The converted data can be transmitted from data processing module 104 to database 116 and/or data storage system according to a number of formations including for example, SOAP, BitTorrent, and Hypertext Transfer Protocol (HTTP). HTTP is known to those of skill in the art and is described in Andrew S. Tanenbaum, Computer Networks 651-56 (4th ed. 2003), the content of which is hereby incorporated by referenced herein. The BitTorrent protocol is also known to those of skill in the art and is defined at http://www.bittorrent.org/protocol.html.

In step S210, a change in the data is detected. A change in data can be detected through a variety of means. For example, the data source system can be polled periodically so as to allow for a comparison of the data stored in the data storage system. Alternatively, the data source system can maintain a log of all data changes. In still another embodiments, a check sum can be computed for each data record. These checksums can be compared to detect in the record has changed. In yet another embodiment, an observer function is implemented on the interface 112 and/or data processing system 104. The observer function receives notification of a data change and causes an update to occur. The observer design pattern is described in Bernd Bruegge & Allen H. Dutoit, Object-Oriented Software Engineering 504 (2000), the content of which is hereby incorporated by reference herein.

Data updates can also be handled with proprietary technologies such as ADOBE® LIVECYCLE® Data Services.

In step S212, data is modified. While much data can be extracted from a third party data source, it also is within the scope of the present invention for data to be added through the data processing module 114. For example, in an e-commerce application, the retailer who controls the data processing system 104 adds or modifies price data for one or more products. Also, such modified data can be protected from being overwritten during data updates in any of a number of ways known to those skilled in the art. In one embodiment, a flag is used to indicate that the particular data or data field should not be updated when updating the data from a data source system. In another embodiment, certain data fields such as price are designated as fields that should not be automatically updated. Control over data updates can be highly granular, i.e., the system can be configured so that other fields in a data record are updated while or more particular fields are not updated. The fields to be updated/not updated can vary from record to record. For example, in an e-commerce application, price data for one product can be updated automatically, while price data for another product is not updated automatically.

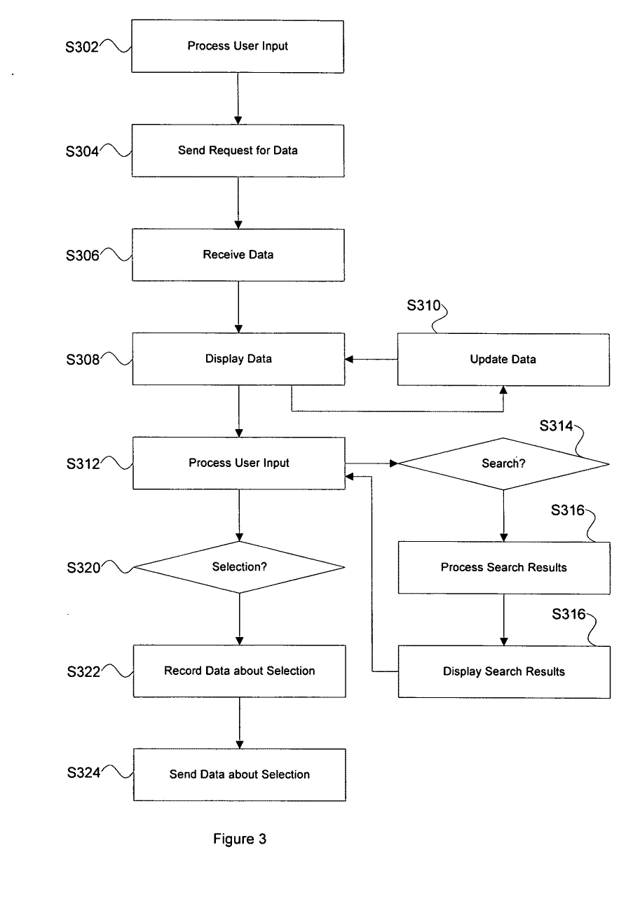

Referring now to FIG. 3, a flowchart 300 depicts a process for data processing according to the present invention more particularly a process for presenting data to a user, responding to user input, and accumulating metadata about the user and/or the product, such as for example, by client 108. In step S302, user input is processed. User input includes the full range of actions transmitted via peripherals now known and later discovered. Exemplary means for user input include, but are not limited to, keyboards, mice, trackballs, touch screens, joysticks, microphones, brain-computer interfaces, image scanner, computer speech recognition devices, cameras, barcode readers and the like. Exemplary inputs include, but are not limited to, typing of Uniform Resource Locator (URL) and clicking on a hyperlink or an icon.

In step S304, a request for data is sent to a remote system, for example systems 104 and/or 106, or data processing modules 114 and/or 120. The request can be defined by one or more standards known to those of skill in the art or can be a defined by a proprietary standard. Exemplary formats for the request include, but are not limited to, HTTP, SOAP, and BitTorrent.

In step S306, data is received in response to the request. The form of the data can be defined by one or more standards known to those of skill in the art or can be a defined by a proprietary standard. Exemplary formats for the request include, but are not limited to, HTTP, SOAP, BitTorrent, and AMF.

In step S308, the data is displayed. The data can be displayed with any display technology known to those of skill in the art. Exemplary display technology includes the FLASH®, AIR®, and ACROBAT® platforms available from Adobe Systems of San Jose, Calif., and Internet browsers such as INTERNET EXPLORER®, available from Microsoft Corporation of Redmond, Wash., FIREFOX®, available from the Mozilla Foundation of Mountain View, Calif., and OPERA®, available from Opera Software AS of Oslo, Norway.

In step S310, the client 108 communicates with the remote system to determine if data for one or more product has been updated. The client 108, the remote system, or both can initiate the communication in step S310. An example of updated data includes data regarding quantity and price. By communicating with the remote system as the user is browsing, the user is apprised of changes in quantity so that the user does not waste time considering a product that is no longer in stock. Also, providing the user with an update as to quantity can create a perception of scarcity, motivating the user to purchase the product before quantities are exhausted. Updates can be detected according to the paradigms described herein including polling, channels, and subscribing to a service.

In embodiments using the ADOBE® AIR® platform updated data can be propagated not only to traditionally dynamic mediums such as FLASH® content, but also to traditionally static mediums such as PDF files. For example, as items are added to a shopping cart, a purchase order in PDF format can be dynamically generated and updated.

In step S312, additional user input is processed. If the user input is search request (S314), the search is executed. The search can be executed on the client 108 or on a remote system such as data processing modules 114 and 120. The search results are processed (S316), which can include conducting the search, ordering the results, receiving the results, formatting the results, storing the results and the like, and displayed (S318). After the results are displayed, the method returns to step S312, where additional user input is processed.

If the user input is a selection of one or more products (S320), data about the selection is recorded (S322). For example, in an embodiment of the system used for e-commerce, when a product is selected, data can include information about how the product was located and attributes of the product. Attributes of the product can include information such as size or color. Such attributes are stored locally on the client 108. In embodiments of the invention utilizing FLASH® or AIR® technologies, the attributes can be stored as Local Stored Objects (LSOs), allowing the attributes to be retained, even when a user deletes cookies from the client 108. In other embodiments, attributes can be stored as cookies or in other formats as known to those of skill in the art. Cookies are described in H. M. Deitel et al., Internet & World Wide Web: How to Program 1060-68 (2000), the contents of which is hereby incorporated by reference herein.

It should be recognized that it is within the skill of those in the art to create other artifacts or substitutes having the attributes of LSOs or cookies so that the attributes are stored locally on the client 108 as herein described for use with an application not specifically described herein.

Additionally or alternatively, information regarding the manner in which a user selected the product can be stored as metadata within the product. Stored information can include, but is not limited to, information regarding search terms and information regarding click stream.

In step S324, data about the selection is transmitted to a remote system. The data can be transmitted in a variety of formats. For example, the entire modified binary data file (e.g. an AMF file) can be sent to the remote system. Alternatively, only the new data can be sent. In some embodiments, the remote system sends all or a portion of the data about the selection to a third party, for example the owner of the data source system(s) 102.

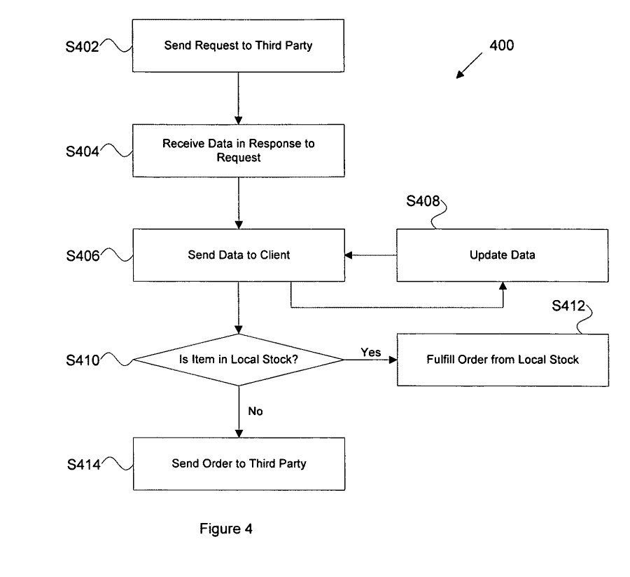

The inventions described herein are further refined with respect to FIG. 4. FIG. 4 is a flowchart 400 depicting a method according to the present invention for dynamically filling an order that can be performed separately or in conjunction with any of the inventions described herein.

In step S402, a request for information is sent to a third party, such as a manufacturer or wholesaler. In some embodiments, the third party implements a data source system 102 as described herein. However, the method is not limited to such an embodiment. In other embodiments, the request is for all product information available from the third party or is limited to specific information such as quantity. The request can be in accordance with any of the communications protocols described herein or any protocol now known or later discovered.

In step S404, a response to a request for information is received from the third party. The response may be in accordance with any of the communications protocols described herein or any protocol now known or later discovered.

In step S406, data is sent to a client. Data can be sent in accordance with any of the communications protocols described herein or any protocol now known or later discovered. In some embodiments, data is sent as an AMF file or is provided as an XML stream.

In step S408, the data is updated. As described herein, data can be updated in a variety of ways. For example, the system implementing this method can periodically poll the third party for updates to the data. Alternatively, the system implementing this method can receive updates from the third party. For example, the system can subscribe to an XML feed from the third party. As updates are received, the updates are sent to the client. This allows for the client to receive current product information such as stock. In some embodiments, all updates are sent to the client. In other embodiments, only updates that are relevant to what the client is viewing are sent to the client. Such an embodiment can be implemented by setting up separate channels to which the client can subscribe. For example, the client can subscribe to a channel for bathroom fixture updates when viewing bathroom fixtures.

In step S410, an order is received from the client. The order can be communicated from the client in accordance with any of the communications protocols described herein or any protocol now known or later discovered.

In step S412, the retailer's inventory is queried to determine if the product is in stock. If the product is in stock, the order is filled from the retailer's stock (S414). If the product is not in the retailer's stock, data regarding the order is automatically sent to the third party for fulfillment. Data regarding the order can include, e.g., product specifications, quantity, and shipping information. Data regarding the order can also include the purchases payment information such as a credit card number. In such an embodiment, responsibility for payment processing is delegated to the party shipping the goods (in this case, the third party). Alternatively, the retailer can handle payment processing.

Information regarding click stream and search terms can be used to enhance future searches for the product and provide insight into how consumers view a product. Consider the following scenarios in which the inventive concepts are used to provide an electronic commerce website for the sale of golf equipment.

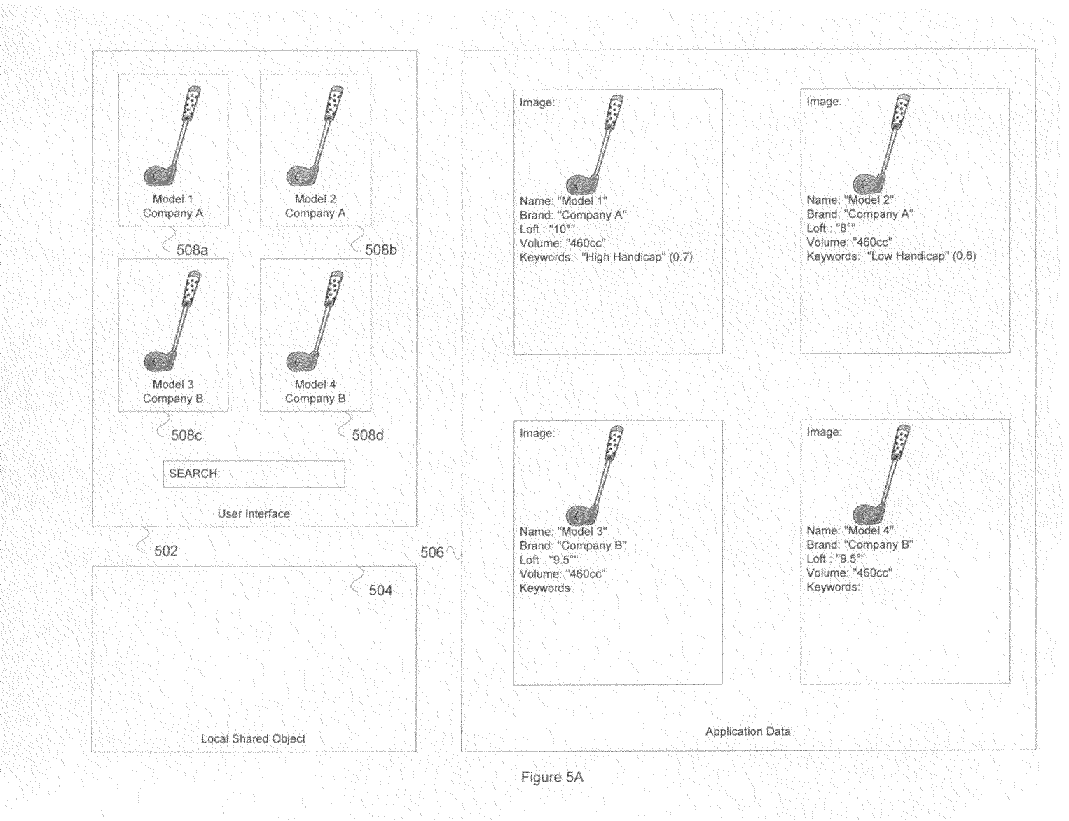

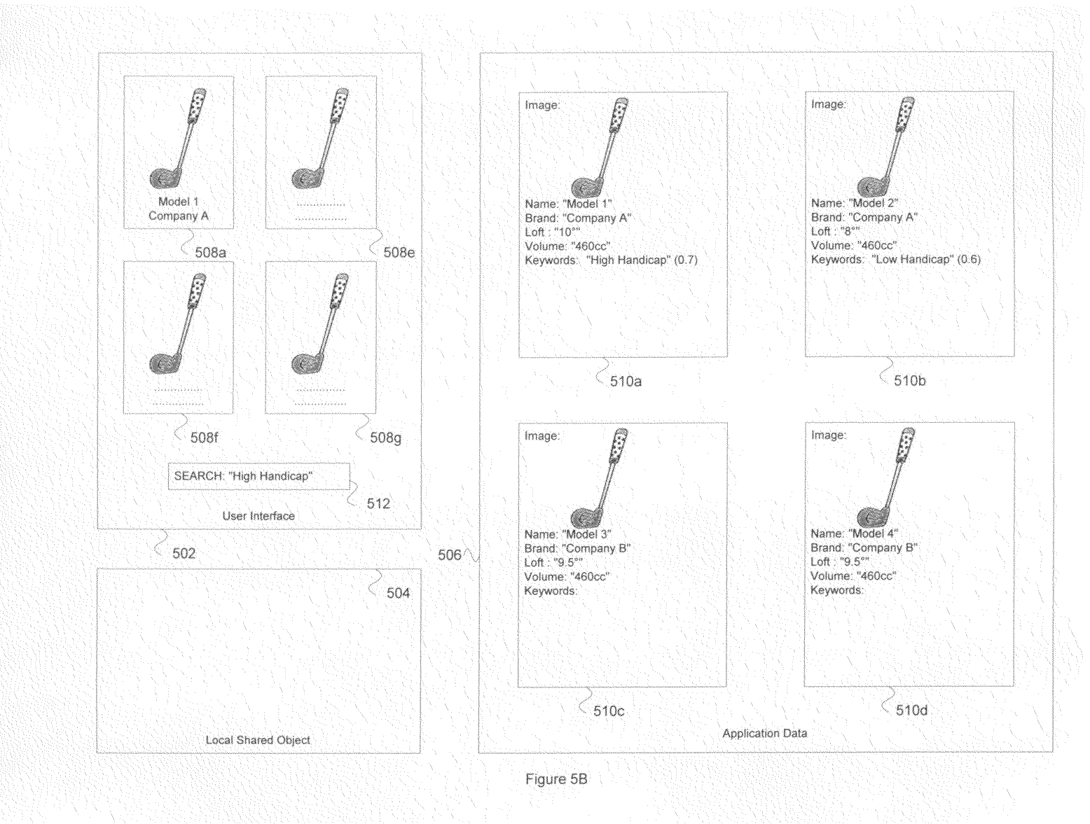

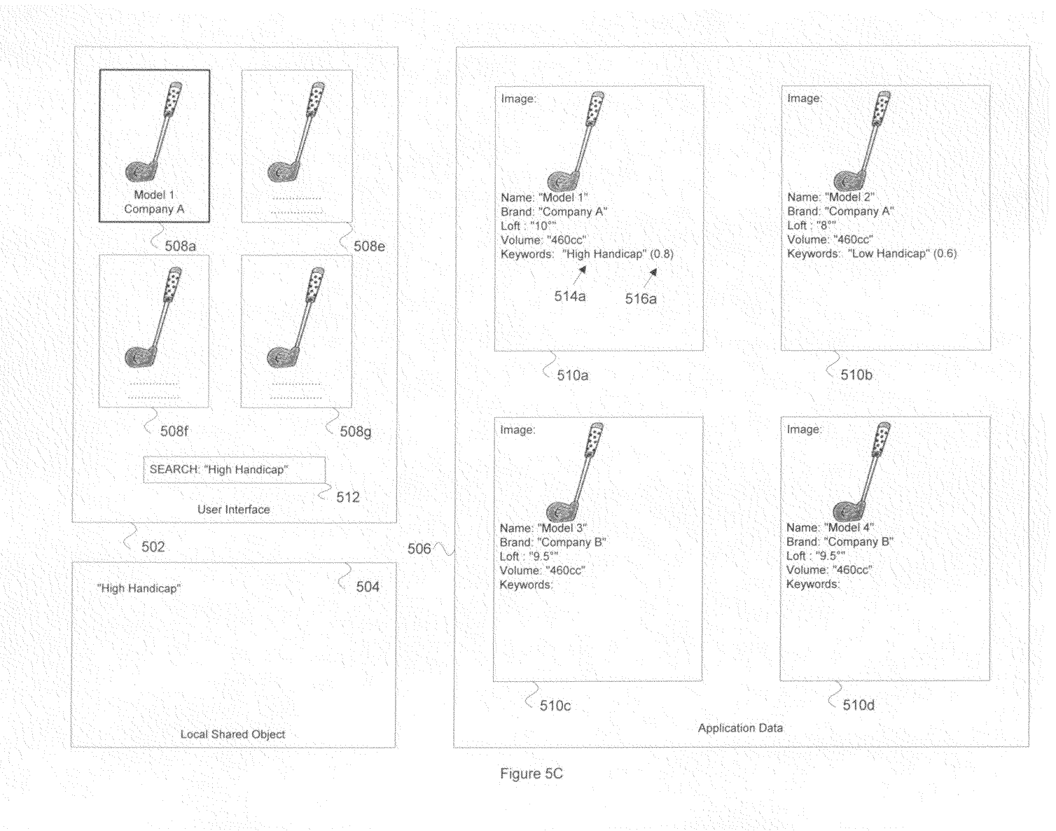

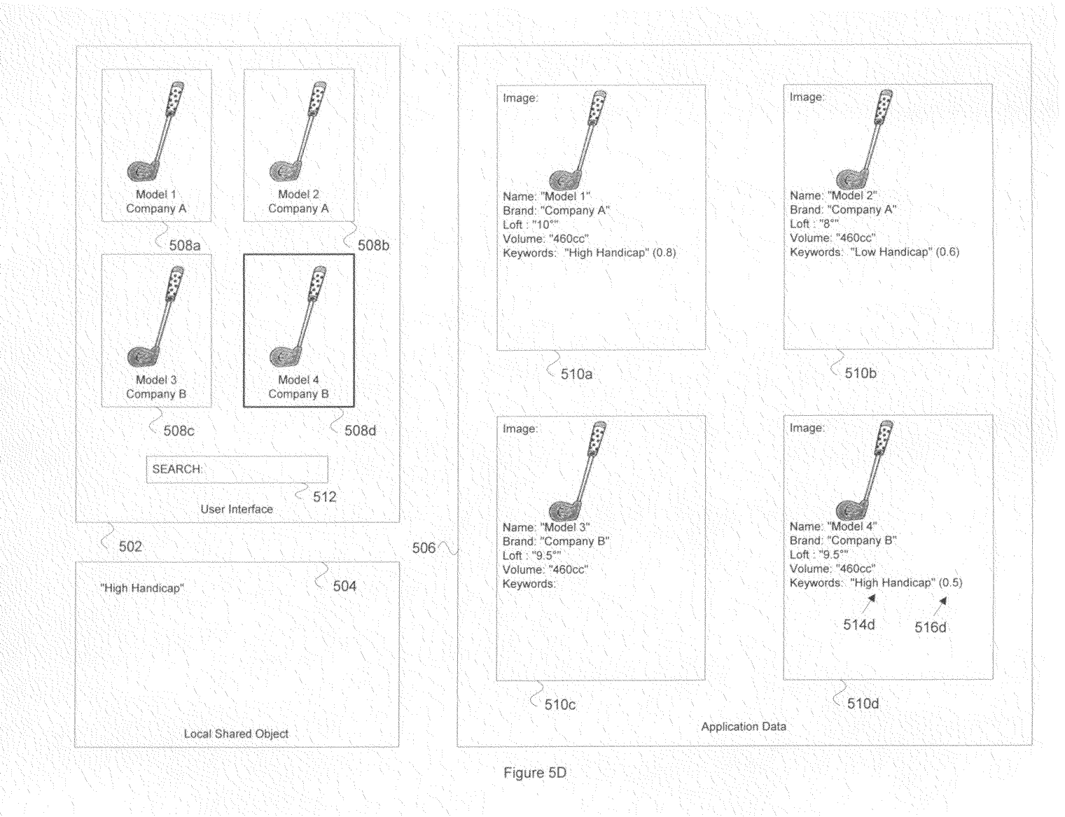

Referring to FIGS. 5A-5D, snapshots of the user interface 502, local shared object 504, and application date 506 are depicted. Data regarding golf equipment is provided from a variety of manufacturers, in this example, Companies A and B.

In FIG. 5A, user interface 502 displays representations 508a-d of each of the four products 510a-d displayed in application data 506. (Additional products stored in the application data are not shown.) The Local Shared Object 504 is devoid of relevant data in this example, but can contain relevant data in many implementations.

In FIG. 5B, the user has searched for “High Handicap” as illustrated in search input 512 of user interface 502b. A number are displayed 508a, 508e-g.

In FIG. 5C, product 508a is selected (depicted by the thick outline). Selection can be defined to include many activities as may be advantageous in various scenarios. For example, selection can include clicking on a product, viewing a product for a defined period of time, placing a product in a shopping cart, and/or purchasing a product.

After product 508a is selected, product 510a is modified to store data about the manner in which the user selected product 508a. In this embodiment, key words 514a are associated with relevance scores 516a. The selection of a product indicates that the keyword may be relevant or irrelevant, and the relevance score can be adjusted accordingly. The relevance score can be used for a variety of purposes including ordering the results of searches (e.g. by listing products with the highest relevance values for the search first). Additionally, Local Shared Object 504 has been altered to include “High Handicap.”

In FIG. 5D, the user has cleared the search in user interface 502. The user then selected product 508d. The system knows that the user is interested in golf clubs designed for individuals with a “High Handicap” because this information is stored in Local Shared Object 504. The system can then intuit that product 508d/510d may be a “High Handicap” club. Accordingly, the system adds “High Handicap” as metadata 514d to product date 510d and assigns a relevance value 516d. Relevance value 516d can in some embodiments, be assigned arbitrarily.

In other embodiments, the metadata collected about users and products can be analyzed using known data mining algorithms to produce product recommendations. Such analysis can occur on the client 108, or in any of the systems 102, 104, 106 described herein.

In some embodiments of the invention, data stored on client 108 is used to provide a user with information regarding previous activity. For example, data regarding light fixtures can be stored as an LSO for later viewing. Other data that can be stored includes browsing trails, i.e. the path that a user takes through multiples screens. In some embodiments, client 108 periodically communicates with the data processing and/or data storage systems to update data regarding the products stored on the client. Such updates occur without user interaction.

For example, if a user views a lighting fixture and then terminates the browsing session, the client 108 can communicate with the data processing and/or data storage systems to received updated data such as price or quantity available. Once this information is received, the client 108 can alert the user that the price has been lowered or that limited quantities of the product are available.

In some embodiments, the entire browsing state is stored locally on the client. Such an embodiment allows the user to resume browsing after a planned or unplanned interruption.

The concepts described herein are further explained with reference again to the system of FIG. 1. Data source system 102 provides a web service, accessible via a URL. Data processing system 104 accesses this web service, for example, using SOAP, and requests data from the data source system 102. Alternatively, interface 112 is designed specifically for interaction with the data processing system 104. This data is returned to the data processing system 104, for example, as XML encapsulated within a SOAP envelope.

The data is then processed by the data processing system 104. Such processing preferably includes the conversion of the data to a binary format such as the AMF format for more compact storage and faster transmission. Processing can also include the modification or insertion of data fields such as price. The formatted data can be stored locally or exported to a data storage system 106.

The data processing system 104 can periodically poll the data source system 102 to receive updates to data. For example, the data processing system can periodically request the XML file provided as a web service. Alternatively, the data processing system 104 can subscribe to the service provided by the data source system 102 and receive notifications from the data source system 102.

The data processing system 104 provides data to an application on client 108. The data is preferably transferred in a binary format such as AMF. As the user utilizes the application, data processing system 104 transmits and receives updated data to and from the client. In such a system, updated data can be used to modify information as the user is viewing the information. Moreover, data from one user can be propagated to other users; for example, the number of available items can be updated for all users when a user places one of the items in a shopping cart. User data and order data are seamlessly passed from the client 108 through the data processing system 104 to the data source system 102 as appropriate.

Accordingly, the inventions herein allow for e-commerce and other data intensive applications to be deployed quickly and updated effortlessly. The inventions allow e-commerce applications to behave more like traditional shopping experiences by presenting users with a more dynamic and intelligent application.

The functions of several elements can, in alternative embodiments, be carried out by fewer elements, or a single element. Similarly, in some embodiments, any functional element can perform fewer, or different, operations than those described with respect to the illustrated embodiment. Also, functional elements (e.g., modules, databases, computers, clients, servers, and the like) shown as distinct for purposes of illustration can be incorporated within other functional elements, separated in different hardware or distributed in a particular implementation.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

### INCORPORATION BY REFERENCE

All patents, published patent applications, and other references disclosed herein are hereby expressly incorporated by reference in their entireties by reference.

### EQUIVALENTS

Those skilled in the art will recognize, or be able to ascertain using no more than routine experimentation, many equivalents of the specific embodiments of the invention described herein. Such equivalents are intended to be encompassed by the following claims.

What is claimed is:

1. A method of content presentation comprising:
receiving product data;
allowing the product to be selected;
storing information regarding the manner in which the product was selected; and
sending the information to a module.

2. The method of claim 1, wherein the data is in action message format.

3. The method of claim 2, further comprising:
converting the data from action message format to vector graphics format.

4. The method of claim 1, further comprising:
displaying a graphical representation of the product data.

5. The method of claim 1, further comprising:
receiving a search query.

6. The method of claim 5, further comprising:
processing the search query.

7. The method of claim 5, wherein the step of storing information regarding the manner in which the product was selected further comprises:
storing data about the search query in the product data.

8. The method of claim 5, wherein the step of storing information regarding the manner in which the product was selected further comprises:
storing data about the search query as data as user data.

9. The method of claim 8 further comprising adding user data to product data for a selected product.

10. The method of claim 1, further comprising:
receiving updated product data; and
displaying the updated product data.

11. A computer-readable medium whose contents cause a computer to perform a method of content presentation comprising:
receiving data describing a product;
allowing the product to be selected;
storing information regarding the manner in which the product was selected; and
sending the information to a module.
